(19) United States
(12) Patent Application Publication
(10) Pub. No.: US 2017/0232842 A1
(43) Pub. Date: Aug. 17, 2017

(54) HUD CLUSTER

(71) Applicant: PANASONIC AUTOMOTIVE SYSTEMS COMPANY OF AMERICA, DIVISION OF PANASONIC CORPORATION OF NORTH AMERICA, PEACHTREE CITY, GA (US)

(72) Inventors: SACHIKO KOBAYASHI, NOVI, MI (US); PATRICK HANSLITS, CLARKSTON, MI (US); DONALD ALLEN TURNER, LIVONIA, MI (US); DAVID LYON, HUNTINGTON WOODS, MI (US); GARY L. BRADDOCK, GROSSE POINTE, MI (US); NARAYANI MITAL, ROYAL OAK, MI (US)

(73) Assignee: PANASONIC AUTOMOTIVE SYSTEMS COMPANY OF AMERICA, DIVISION OF PANASONIC CORPORATION OF NORTH AMERICA

(21) Appl. No.: 15/428,181

(22) Filed: Feb. 9, 2017

Related U.S. Application Data
(60) Provisional application No. 62/294,476, filed on Feb. 12, 2016.

(51) Int. Cl. B60K 35/00; G02B 27/01

(52) U.S. Cl. CPC B60K 35/00; G02B 27/0101; B60K 2350/1056; B60K 2350/2052; B60K 2350/1076; G02B 2027/0147; G02B 2027/0145

(57) ABSTRACT

A head up display cluster arrangement for a motor vehicle includes a dashboard disposed within a passenger compartment of the motor vehicle. The dashboard includes an instrument cluster surface disposed above a steering column of the motor vehicle. An image source is disposed on, or adjacent to, the dashboard. The image source emits an illuminated image. A mirror is positioned to reflect the emitted illuminated image onto the cluster surface.

### CROSS-REFERENCED TO RELATED APPLICATIONS

This application claims benefit of U.S. Provisional Application No. 62/294,476 filed on Feb. 12, 2016, the disclosure of which is hereby incorporated by reference in its entirety for all purposes.

### FIELD OF THE INVENTION

The disclosure relates to the field of automotive infotainment systems, and, more particularly, to a head up display (HUD) cluster in a motor vehicle.

### BACKGROUND OF THE INVENTION

Traditional instrument cluster displays are made from mechanical gauges, are liquid crystal display (LCD) based, or are thin film transistor (TFT) based. Such known displays are rather bulky and are not reconfigurable. These displays are rectangular in shape so there are limitations with design and packaging.

### SUMMARY

The present invention may provide a head up display that may be used with a small source and optics to project the image onto the instrument cluster such that how the instrument cluster is displayed is reconfigurable. With the inventive HUD cluster arrangement, package size and weight are reduced relative to known instrument clusters. The inventive HUD cluster arrangement may be reconfigurable or “free-form” in that the mirror and display may easily be made any desired shape (e.g., nonrectangular) to conform to the available area on the dashboard, which provides packaging benefits.

Small source displays, such as LCDs, and mirrors for use in HUDs may be packaged above the steering column. The mirror may project an enlarged image, which may be a non-rectangular image, onto the cluster area.

The invention may enable the cluster display to be very thin and to take on any shape (e.g., a shape without corners) to provide smaller packaging. The invention may call for a smaller LCD than the twelve to fourteen-plus inch displays that are currently being used, so the invention could also reduce weight and cost as compared to current cluster displays.

Another advantage is that the invention may provide a larger image size and free-form shape that enables the HUD and the cluster information to be combined as one cluster display in the driver's view.

In one embodiment, the invention comprises a head up display cluster arrangement for a motor vehicle, including a dashboard disposed within a passenger compartment of the motor vehicle. The dashboard includes an instrument cluster surface disposed above a steering column of the motor vehicle. An image source is disposed on, or adjacent to, the dashboard. The image source emits an illuminated image. A mirror is positioned to reflect the emitted illuminated image onto the cluster surface.

In another embodiment, the invention comprises a head up display cluster arrangement for a motor vehicle, including an instrument cluster having a surface. An electronic display produces an image indicative of an operational status or operational parameter of the motor vehicle. A mirror is positioned to reflect the image onto the instrument cluster surface such that the image on the instrument cluster surface is larger than the image produced by the electronic display.

In yet another embodiment, the invention comprises a head up display cluster arrangement for a motor vehicle, including an instrument cluster surface facing a driver's seat within a passenger compartment of the motor vehicle. An image source is disposed on, or adjacent to, a dashboard of the motor vehicle. The image source emits an illuminated image. A non-rectangular mirror is positioned to reflect the emitted illuminated image onto the instrument cluster surface such that the image on the instrument cluster surface is non-rectangular.

### BRIEF DESCRIPTION OF THE DRAWINGS

A better understanding of the present invention will be had upon reference to the following description in conjunction with the accompanying drawings.

FIG. 1 is a schematic side view of one embodiment of an HUD cluster arrangement of the present invention.

FIG. 2 is a perspective view of the instrument cluster of FIG. 1 with circular mirrors.

FIG. 3 is a plan view of the instrument cluster of FIG. 1 with rectangular mirrors.

FIG. 4 is a flow chart of a head up display method of the present invention for a motor vehicle.

### DETAILED DESCRIPTION OF THE PREFERRED EMBODIMENTS

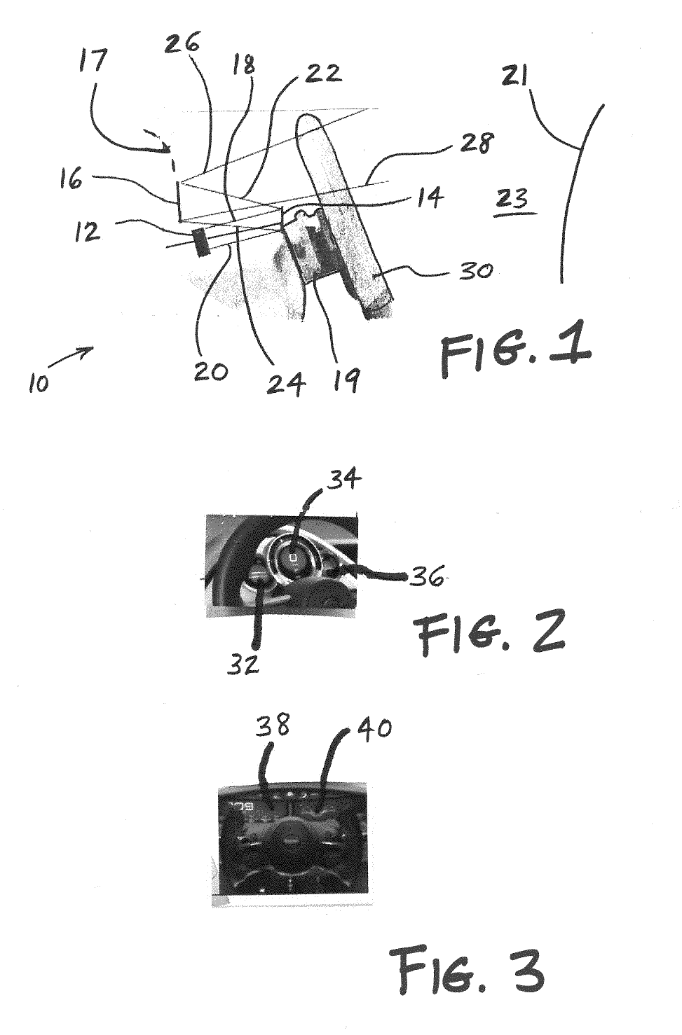

FIG. 1 illustrates one embodiment of an HUD cluster arrangement 10 of the present invention including an LCD image source 12, a mirror 14, and a cluster surface 16. Both LCD source 12 and cluster surface 16 may be on or adjacent to a dashboard 17 of the motor vehicle. Cluster surface 16 may be disposed above a steering column 19 of the motor vehicle, and may face a driver's seat 21 within a passenger compartment 23 of the motor vehicle. LCD source 12 may emit an illuminated image toward the passenger compartment in a direction substantially perpendicular to dashboard 17. The illuminated image emitted by the image source may be indicative of an operational status or operational parameter of the motor vehicle, such as a temperature, fluid pressure, speed, how full the gas tank is, battery voltage, etc. The illuminated image may be reflected by mirror 14. An envelope of the emitted image is indicated at 18 and 20. An envelope of the image reflected off of mirror 14 is indicated at 22 and 24. As can be seen in FIG. 1, the envelope enlarges with distance from mirror 14, as lines 22 and 24 diverge away from each other with distance from mirror 14. Thus, mirror 14 may magnify or enlarge the image received from LCD source 12 as presented on cluster surface 16.

The image reflected off mirror 14 is again reflected off of cluster surface 16, which may be the surface of a sheet of glass or transparent plastic, for example. The image reflected off of cluster surface 16 is within the field of view of the driver, boundaries of which are indicated at 26 and 28.

There may be several arrangements 10 provided around steering wheel 30 to provide several distinct images on different areas of cluster surface 16. FIG. 2 illustrates an embodiment in which there are three arrangements 10 with three respective circular mirrors. Each of the three mirrors reflects a respective one of the three circular images 32, 34, 36 onto the cluster surface.

FIG. 3 illustrates an embodiment in which there are two arrangements 10 with two respective rectangular mirrors. Each of the two mirrors reflects a respective one of the three rectangular images 38, 40 onto the cluster surface.

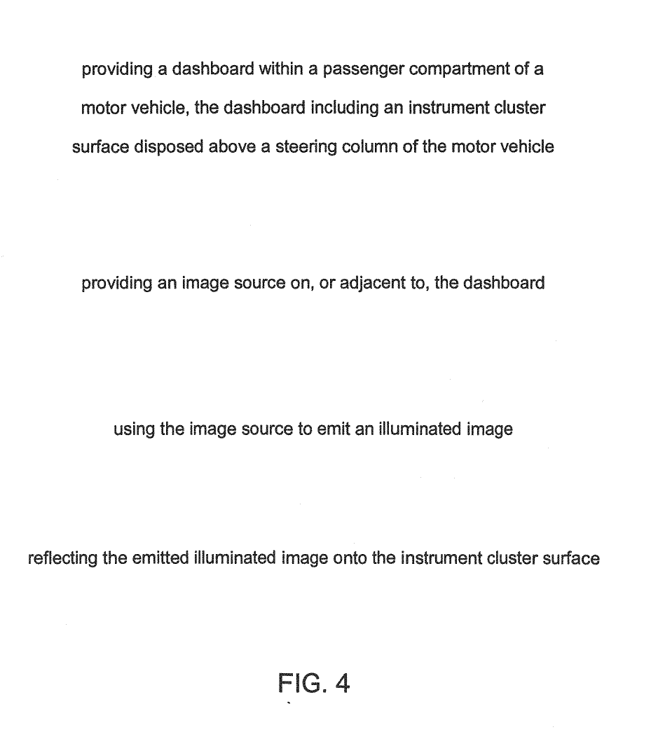

FIG. 4 illustrates a head up display method 400 of the present invention for a motor vehicle. In a first step 402, a dashboard is provided within a passenger compartment of the motor vehicle. The dashboard includes an instrument cluster surface disposed above a steering column of the motor vehicle. For example, dashboard 17 is provided within passenger compartment 23. Dashboard 17 includes an instrument cluster surface 16 disposed above steering wheel 30.

Next, in step 404, an image source is provided on, or adjacent to, the dashboard. For example, an LCD image source 12 may be mounted on dashboard 17.

In a next step 406, the image source is used to emit an illuminated image. For example, LCD image source 12 may emit an illuminated image as indicated between 18 and 20 in FIG. 1.

In a final step 408, the emitted illuminated image is reflected onto the instrument cluster surface. That is, the illuminated image between 18 and 20 may be reflected by mirror 14, as indicated between 22 and 24, and onto instrument cluster surface 16.

The invention has been described as including a HUD having a LCD as its source. However, it is to be understood that the invention may alternatively include a HUD having a projector instead of a display as a source.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display cluster arrangement for a motor vehicle, comprising:
a dashboard disposed within a passenger compartment of the motor vehicle and including an instrument cluster surface disposed above a steering column of the motor vehicle;
an image source disposed on, or adjacent to, the dashboard, the image source being configured to emit an illuminated image; and
a mirror positioned to reflect the emitted illuminated image onto the cluster surface.

2. The arrangement of claim 1 wherein the image source is disposed on or adjacent to the dashboard.

3. The arrangement of claim 1 wherein the image source comprises a liquid crystal display.

4. The arrangement of claim 1 wherein the image source is configured to emit the illuminated image toward the passenger compartment in a direction substantially perpendicular to the dashboard.

5. The arrangement of claim 1 wherein the mirror is configured to enlarge the illuminated image such that the image on the cluster surface is larger than the image as emitted by the image source.

6. The arrangement of claim 1 wherein the mirror and the image on the cluster surface are non-rectangular.

7. The arrangement of claim 1 wherein the mirror and the image on the cluster surface are circular.

8. The arrangement of claim 1 wherein the illuminated image emitted by the image source is indicative of an operational status or operational parameter of the motor vehicle.

9. A head up display cluster arrangement for a motor vehicle, comprising:
an instrument cluster having a surface;
an electronic display configured to produce an image indicative of an operational status or operational parameter of the motor vehicle; and
a mirror positioned to reflect the image onto the instrument cluster surface such that the image on the instrument cluster surface is larger than the image produced by the electronic display.

10. The arrangement of claim 9 wherein the electronic display comprises a liquid crystal display.

11. The arrangement of claim 9 wherein the electronic display and the instrument cluster surface are each on or adjacent to a dashboard disposed within a passenger compartment of the motor vehicle.

12. The arrangement of claim 9 wherein the instrument cluster surface is disposed above a steering column of the motor vehicle.

13. The arrangement of claim 9 wherein the electronic display faces a passenger compartment of the motor vehicle in a direction substantially perpendicular to a dashboard of the motor vehicle.

14. The arrangement of claim 9 wherein the mirror and the image on the cluster surface are non-rectangular.

15. The arrangement of claim 9 wherein the mirror and the image on the cluster surface are circular.

16. A head up display cluster arrangement for a motor vehicle, comprising:
an instrument cluster surface facing a driver's seat within a passenger compartment of the motor vehicle;
an image source disposed on, or adjacent to, a dashboard of the motor vehicle, the image source being configured to emit an illuminated image; and
a non-rectangular mirror positioned to reflect the emitted illuminated image onto the instrument cluster surface such that the image on the instrument cluster surface is non-rectangular.

17. The arrangement of claim 16 wherein the instrument cluster surface is disposed above a steering column of the motor vehicle.

18. The arrangement of claim 16 wherein a shape of the image on the instrument cluster surface matches a shape of the mirror.

19. The arrangement of claim 16 wherein the mirror is configured to enlarge the illuminated image such that the image on the instrument cluster surface is larger than the image as emitted by the image source.

20. The arrangement of claim 16 wherein the illuminated image emitted by the image source is indicative of an operational status or operational parameter of the motor vehicle.
